(19) United States
(12) Patent Application Publication
(10) Pub. No.: US 2016/0354873 A1
(43) Pub. Date: Dec. 8, 2016

(54) APPARATUS FOR SUPPORTING BACKING MEMBER IN ENCLOSED STRUCTURES

(71) Applicant: Caterpillar Inc., Peoria, IL (US)

(72) Inventors: Huijun Wang, Peoria, IL (US); Danny L. McCaherty, Washington, IL (US); Yan Shao, Peoria, IL (US); Kendall R. Powell, Peoria, IL (US); David R. Griffith, East Peoria, IL (US)

(73) Assignee: Caterpillar Inc., Peoria, IL (US)

(21) Appl. No.: 14/730,322

(22) Filed: Jun. 4, 2015

(51) Int. Cl. B23K 37/04

(52) U.S. Cl. CPC B23K 37/0435

(57) ABSTRACT

An apparatus for supporting a backing member in an enclosed structure is disclosed. The enclosed structure includes a first plate defining an opening therethrough. The apparatus is configured to be disposed within the enclosed structure. The apparatus includes a clamp member and a support member configured to rotatably support the clamp member. The clamp member is rotatable about a rotation axis defined by the support member. The support member is further configured to abut a second plate spaced apart from the first plate. The clamp member is configured to be moved along the rotation axis relative to the support member and bias the backing member to contact with the first plate along the opening.

### TECHNICAL FIELD

The present disclosure relates to a system for welding of an enclosed structure, and more particularly relates to an apparatus for supporting a backing member for welding a plate of the enclosed structure.

### BACKGROUND

Enclosed structures, such as a boom member of a machine, may experience cracking failures due to prolonged operation. Such cracking failures are repaired by gouging and welding the enclosed structure at the crack location. In order to perform welding, a weld root opening is defined in a plate along the location of the crack in the enclosed structure. Further, a backing member made from a steel or nonmetallic material such as a ceramic tile is required to close the weld root opening from bottom of the plate and to perform welding operation along the weld root opening to repair the cracking failure in the enclosed structure. However, the enclosed structure does not provide any access for an operator to support the backing member from bottom of the plate and perform inspection of the weld seam. Thus, repairing of the enclosed structure by welding may become a complicated and time consuming process.

European Patent Number 1864744A1 (the '744 patent) discloses a clamping device for weld seam-backing member. The clamping device includes a backing member pressing against two work pieces having a welding gap therebetween. A rod extends through the backing member and has an exposed upper portion extending through a narrower portion of the welding gap into a wider portion of the welding gap. An elastic element is mounted between a bottom face of the backing member and an abutting portion on a lower portion of the rod to bias the backing member to press against the work pieces. The upper portion includes a hooked section having a first width smaller than a width of the narrower portion and a second width perpendicular to and larger than the width of the narrower portion. The rod is turnable to a position in which the second width of the hooked section presses against the work pieces under the action of the elastic element.

### SUMMARY OF THE DISCLOSURE

In one aspect of the present disclosure, an apparatus for supporting a backing member for welding a first plate of an enclosed structure is provided. The first plate defines an opening therethrough. The apparatus is configured to be disposed within the enclosed structure. The apparatus includes a clamp member and a support member configured to rotatably support the clamp member. The clamp member is rotatable about a rotation axis defined by the support member. The support member is further configured to abut a second plate spaced apart from the first plate. The clamp member is configured to be moved along the rotation axis relative to the support member and bias the backing member to contact with the first plate along the opening.

In another aspect of the present disclosure, a system for welding a first plate of an enclosed structure is provided. The first plate defines an opening therethrough. The system is configured to be disposed within the enclosed structure. The system includes a backing member defining a first surface and a second surface distal to the first surface. The system further includes an apparatus for supporting the backing member. The apparatus includes a clamp member configured to abut the second surface of the backing member. The first surface of the backing member is configured to abut the first plate. The apparatus further includes a support member configured to rotatably support the clamp member. The clamp member is rotatable about a rotation axis defined by the support member. The support member is further configured to abut a second plate spaced apart from the first plate. The clamp member is configured to be moved along the rotation axis relative to the support member and bias the backing member to contact with the first plate along the opening.

In yet another aspect of the present disclosure, a method of supporting a backing member in an enclosed structure is provided. The enclosed structure has a first plate and a second plate spaced apart from the first plate. The method includes defining an opening in the first plate. The opening defines a longitudinal axis. The method further includes inserting an apparatus, at a first orientation thereof, within the enclosed structure through the opening. The apparatus includes a clamp member and a support member configured to rotatably support the clamp member. In the first orientation, the clamp member is aligned with the longitudinal axis of the opening. The method further includes disposing the support member of the apparatus on the second plate and rotating the apparatus to a second orientation thereof about a rotation axis perpendicular to the longitudinal axis. In the second orientation, the clamp member is oriented at an angle with respect to the longitudinal axis of the opening. The method further includes inserting a backing member through the opening within the enclosed structure. The method further includes aligning the backing member with the longitudinal axis of the opening to at least partially close the opening from inside of the enclosed structure. The method further includes rotating the apparatus about the rotation axis to move the apparatus to the first orientation thereof to support the backing member on the clamp member.

Other features and aspects of this disclosure will be apparent from the following description and the accompanying drawings.

### BRIEF DESCRIPTION OF THE DRAWINGS

FIG. 1 is a partial perspective view of an exemplary enclosed structure having an opening, according to an embodiment of the present disclosure;

FIG. 2 is a perspective view of a backing member to close the opening from inside of the enclosed structure, according to an embodiment of the present disclosure;

FIG. 3 is a perspective view of an apparatus for supporting the backing member of FIG. 2 within the enclosed structure, according to an embodiment of the present disclosure;

FIGS. 4A and 4B illustrate a method of disposing the apparatus within the enclosed structure, according to an embodiment of the present disclosure;

FIGS. 5A to 5C illustrate a method of disposing the backing member within the enclosed structure, according to an embodiment of the present disclosure;

FIGS. 6A to 6C illustrate a method of engaging the apparatus with the backing member, according to an embodiment of the present disclosure; and

FIG. 7 is a flowchart of a method of supporting the backing member within the enclosed structure, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

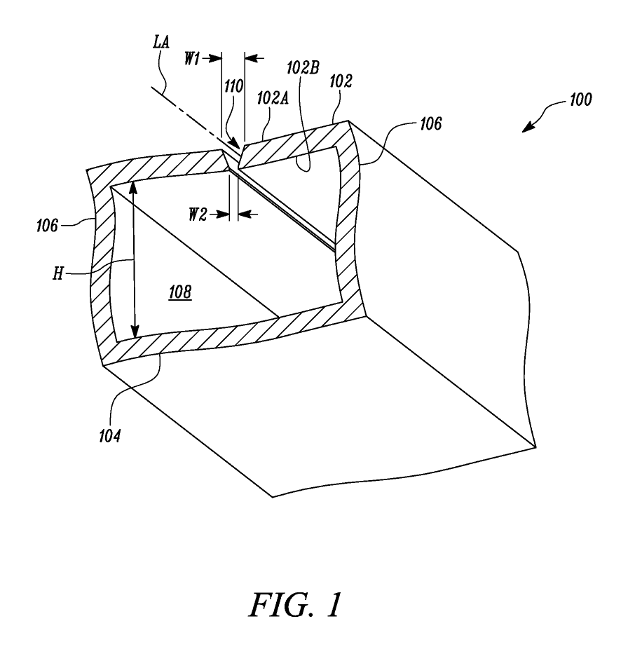

FIG. 1 illustrates a partial perspective view of an exemplary enclosed structure 100 requiring weld repairing. The enclosed structure 100 is used in various applications, such as off-road and on-road vehicles. In an example, the enclosed structure 100 may be an elongate member of a boom assembly used in excavator for performing earth moving operations. In an embodiment, the enclosed structure 100 may correspond to a hollow metallic structure having all sides thereof closed such that inside of the hollow metallic structure is not accessible from outside of the hollow metallic structure. In other embodiments, the enclosed structure 100 may correspond to a metallic plate in a machine structure or any other structure having only one side accessible from outside. In various embodiments, the enclosed structure 100 may have any shape and size.

In the illustrated embodiment, the enclosed structure 100 is an elongate member having a first plate 102 and a second plate 104 spaced at a height ‘H’ from the first plate 102. The enclosed structure 100 further includes a pair of side plates 106 extending between the first plate 102 and the second plate 104 to define a space 108 within the enclosed structure 100. End plates of the enclosed structure 100 are not shown in FIG. 1 for clarity.

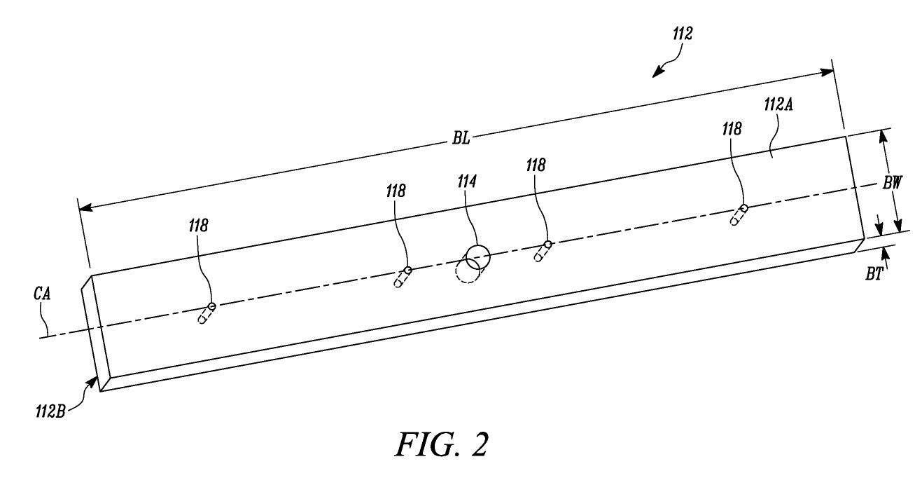

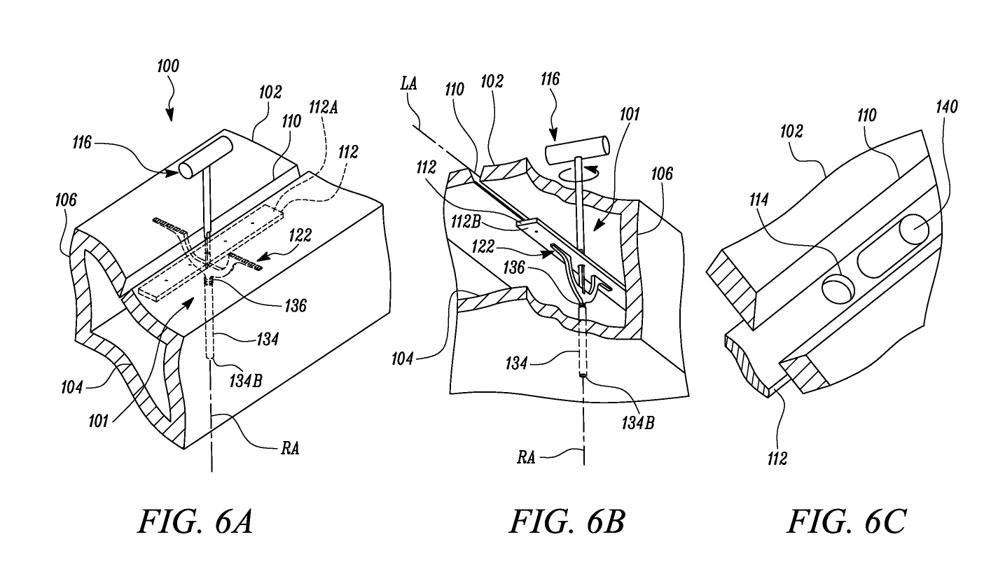

As shown in FIG. 1, an opening 110 is defined in the first plate 102. The opening 110 extends between an outer surface 102A and an inner surface 102B of the first plate 102. To assist welding of the first plate 102 along the opening 110, a system 101 (shown in FIG. 6) is disposed within the enclosed structure 100. The system 101 will be described in detail later with reference FIGS. 2 to 6. The opening 110 is defined in the enclosed structure 100 when repairing of the enclosed structure 100 is required due to damages, such as cracking failures, happened due to prolonged operation. The opening 110 may be defined in the enclosed structure 100 along a direction of the crack to remove the crack and form a weld seam along the opening 110.

In the illustrated embodiment, the opening 110 is defined longitudinally along a length of the first plate 102. Further, the opening 110 defines a longitudinal axis ‘LA’ along a length thereof. In an embodiment, the opening 110 has a first width ‘W1’ adjacent to the outer surface 102A of the first plate 102 and a second width ‘W2’ adjacent to the inner surface 102B of the first plate 102. The second width ‘W2’ is smaller than the first width ‘W1’ of the opening 110. In other embodiments, the first width ‘W1’ and the second width ‘W2’ may be equal. In various embodiments, the first width ‘W1’ and the second width ‘W2’ of the opening 110 may vary based on various parameters including, but not limited to, a thickness of the first plate 102 and a thickness of the weld seam that is to be defined in the first plate 102.

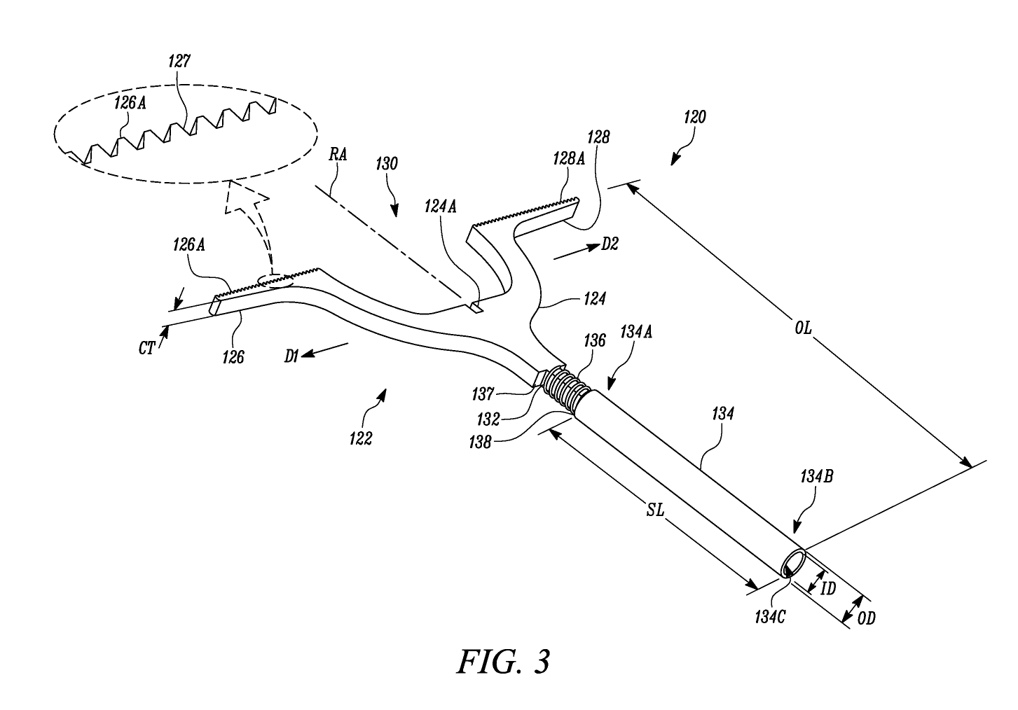

The opening 110 defined in the first plate 102 is closed by the system 101 from inside of the enclosed structure 100 for welding the first plate 102 along the opening 110. The system 101 includes a backing member 112 (shown in FIG. 2) for closing the opening 110 at the second width ‘W2’ and an apparatus 120 (shown in FIG. 3) for supporting the backing member 112 from inside of the enclosed structure 100. The backing member 112 and the apparatus 120 are described in detail with reference to FIG. 2 and FIG. 3, respectively.

FIG. 2 is a perspective view of the backing member 112, according to an embodiment of the present disclosure. Referring to FIGS. 1 and 2, the backing member 112 is configured to be disposed adjacent to the inner surface 102B of the first plate 102 to close the opening 110 from inside of the enclosed structure 100. Thus, welding of the first plate 102 may be performed along the opening 110. In the illustrated embodiment, the backing member 112 is an elongate member having a length ‘BL’ and a width ‘BW’. The length ‘BL’ of the backing member 112 is longer than the length of the opening 110 and the width ‘BW’ of the backing member 112 is greater than the second width ‘W2’ of the opening 110. The backing member 112 includes a first surface 112A and a second surface 112B distal to the first surface 112A. The backing member 112 further defines a thickness ‘BT’ extending between the first surface 112A and the second surface 112B. The thickness ‘BT’ of the backing member 112 is smaller than the second width ‘W2’ of the opening 110. The first surface 112A of the backing member 112 is configured to abut the inner surface 102B of the first plate 102 during welding of the first plate 102 along the opening 110.

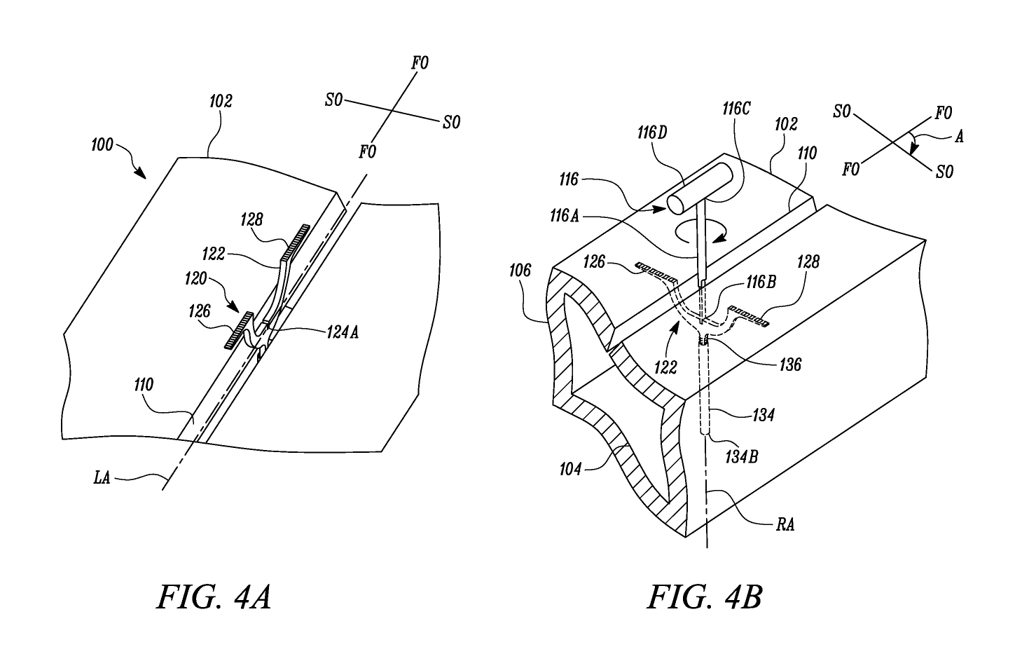

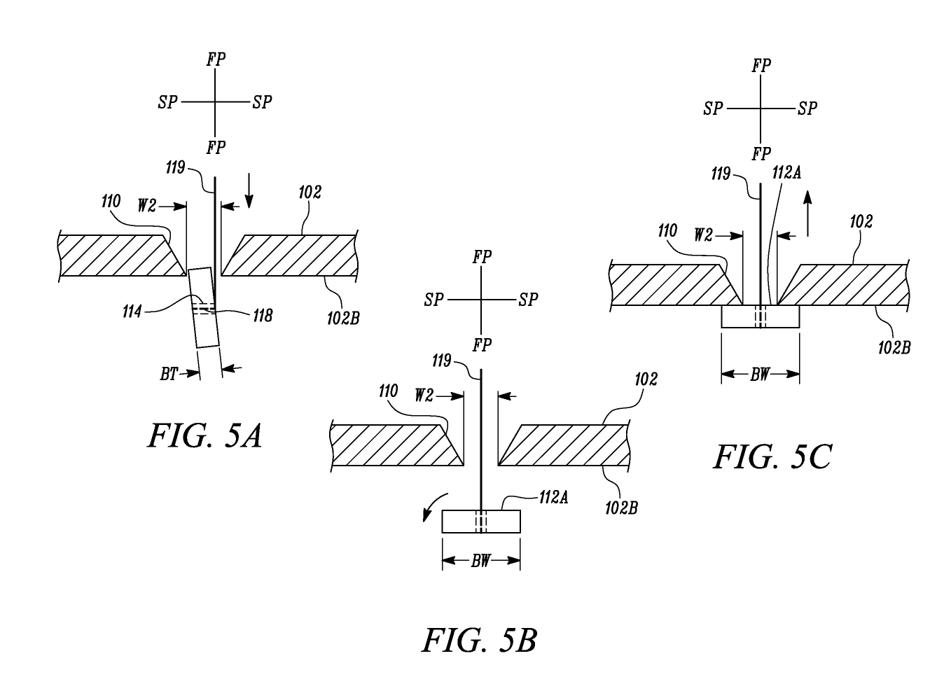

The backing member 112 further includes a first through hole 114 configured to receive an alignment tool 116 (shown in FIG. 4). The first through hole 114 is defined around a centre of the backing member 112. In the illustrated embodiment, the first through hole 114 has a circular cross section to receive the alignment tool 116 therethrough. However, in various embodiments, the cross section of the first through hole 114 may be square, rectangular, elliptical, polygonal or any other suitable shape. Further, the backing member 112 includes a plurality of second through holes 118 defined along a central axis ‘CA’ thereof to receive a string 119 (shown in FIG. 5) therethrough. At least one second through hole 118 is defined adjacent to both ends of the backing member 112. The first through hole 114 is also defined along the central axis ‘CA’.

In the illustrated embodiment, the backing member 112 is made from a ceramic material. In another embodiment, the backing member 112 may be made from a combination of a ceramic plate and a steel plate. In such a case, the ceramic plate may be configured to contact with the inner surface 102B of the first plate 102. In yet another embodiment, the backing member 112 may be made from a plurality of ceramic plates. One or two ceramic plates may be designed to form the first through hole 114. Further, each of the plurality of ceramic plates may include at least one second through hole 118 to receive the string 119.

FIG. 3 illustrates a perspective view of the apparatus 120, according to an embodiment of the present disclosure. Referring to FIGS. 1 to 3, the apparatus 120 is configured to be disposed within the enclosed structure 100. Further, the apparatus 120 is configured to support the backing member 112 from inside of the enclosed structure 100 for welding the first plate 102 along the opening 110. The apparatus 120 includes a clamp member 122 configured to contact the backing member 112 with the first plate 102. The clamp member 122 is further configured to be engaged with the second surface 112B of the backing member 112 to support the backing member 112 within the enclosed structure 100.

In the illustrated embodiment, the clamp member 122 includes a base 124 and a first arm 126 extending from the base 124 along a first direction ‘D1’. The first arm 126 defines a first abutment surface 126A configured to abut the second surface 112B of the backing member 112. The clamp member 122 further includes a second arm 128 extending from the base 124 along a second direction ‘D2’ opposite to the first direction ‘D1’. The second arm 128 defines a second abutment surface 128A configured to abut the second surface 112B of the backing member 112. The first arm 126 and the second arm 128 extend laterally from the base 124 such that a space 130 is defined therebetween to accommodate the backing member 112 having the width ‘BW’. The clamp member 122 further includes an elongate member 132 extending from the base 124. The base 124 further defines a cutout 124A to engage with the alignment tool 116. Though the cutout 124A is illustrated as having a rectangular shape, it may be contemplated that the cutout 124A may have any alternative shape and may be defined at any suitable location in the base 124 to engage with the alignment tool 116. A plurality of notches 127 is defined on the first and second abutment surfaces 126A, 128A of the first and second arms 126, 128, respectively. The plurality of notches 127 may decrease surface contacting areas of the first and second abutment surfaces 126A, 128 such that heating of the first and second arms 126, 128 during welding of the first plate 102 may be minimized.

In an embodiment, the clamp member 122 is formed from a metal plate having a thickness ‘CT’ via a laser cutting process such that the elongate member 132, and the first and second arms 126, 128 are integrally formed with the base 124. The thickness ‘CT’ of the clamp member 122 is smaller than the second width ‘W2’ of the opening 110 such that the clamp member 122 may be inserted into the enclosed structure 100 through the opening 110. In other embodiments, the elongate member 132, and the first and second arms 126, 128 may be separate parts detachably coupled to the base 124.

The apparatus 120 further includes a support member 134 configured to rotatably support the clamp member 122. The support member 134 is further configured to abut the second plate 104. The clamp member 122 is rotatable about a rotation axis ‘RA’ defined by the support member 134. In the illustrated embodiment, the support member 134 is an elongate body having a first end 134A and a second end 134B. The support member 134 further defines a length ‘SL’ between the first end 134A and the second end 134B. The support member 134 further defines a space 134C therein such that the elongate member 132 of the clamp member 122 is rotatably received within the space 134C adjacent to the first end 134A of the support member 134. The second end 134B of the support member 134 is configured to abut the second plate 104. In an embodiment, a plug (not shown) made from an elastic material, a plastic material, a magnetic material or a combination thereof may be attached to the second end 134B of the support member 134 to provide stability to the apparatus 120 while supporting the apparatus 120 on the second plate 104.

In various alternative embodiments, the second end 134B of the support member 134 may rotatably receive the elongate member 132 and the first end 134A of the support member 134 may abut the second plate 104. In an example, the support member 134 may be a tube or a pipe made from a metal. In another example, the support member 134 may be made from a plastic or any other suitable material.

In an embodiment, the support member 134 has a circular cross section defining an outer diameter ‘OD’. The outer diameter ‘OD’ is smaller than the second width ‘W2’ of the opening 110 such that the support member 134 may be inserted through the opening 110. Similarly, the space 134C has a circular cross section defining an inner diameter ‘ID’. Thus, a width of a wall of the support member 134 is defined between the outer diameter ‘OD’ and the inner diameter ‘ID’ thereof. In other embodiments, the cross-section of the support member 134 may be square, rectangular, elliptical, polygonal or any other suitable shape.

In various embodiments, the support member 134 may be made from multiple cylindrical bodies (not shown) having an outer diameter less than the second width ‘W2’ of the opening 110. Each of the cylindrical bodies may have a different length and may be threadingly engaged with each other. Further, a threading length of each of the cylindrical bodies may be varied such that the length ‘SL’ may be adjusted based on the height ‘H’ of the enclosed structure 100. Further, one of the cylindrical bodies may have a hole to rotatably receive the elongate member 132 of the clamp member 122 and another cylindrical body may be configured to abut the second plate 104.

The apparatus 120 further includes a spring member 136 disposed between the clamp member 122 and the support member 134 such that the clamp member 122 moves along the rotation axis ‘RA’ relative to the support member 134. The spring member 136 is further configured to bias the clamp member 122 along the rotation axis ‘RA’. In the illustrated embodiment, the spring member 136 is supported between a first flange 137 defined by the clamp member 122 and a second flange 138 defined by the support member 134. The elongate member 132 is inserted through the spring member 136 and rotatably received within the space 134C adjacent to the first end 134A of the support member 134. The second flange 138 is defined by the wall of the support member 134.

In a normal condition of the spring member 136, the apparatus 120 may define an overall length ‘OL’ extending between one of the first and second abutment surfaces 126A, 128B of the first and second arms 126, 128, respectively, and the second end 134B of the support member 134. The overall length ‘OL’ is greater than the height ‘H’ defined between the inner surface 102B of the first plate 102 and the second plate 104 of the enclosed structure 100. Further, the length ‘SL’ of the support member 134 may be changed depending on the height ‘H’ of the enclosed structure 100.

FIGS. 4A and 4B illustrate an exemplary method of disposing the apparatus 120 within the enclosed structure 100 As shown in FIGS. 4A and 4B, the apparatus 120 is inserted through the opening 110. In an exemplary embodiment, the enclosed structure 100 may be located on a work surface (not shown) and the opening 110 is defined in the first plate 102. The opening 110 is defined at a location in the enclosed structure 100 where a cracking failure is occurred. In an embodiment, the opening 110 may be defined by a gouging process, such as air carbon arc gouging or plasma gouging. However, in other embodiments, the opening 110 may be defined by various machining processes, such as drilling, milling, grinding, filing, tapering or a combination thereof.

Further, as illustrated in FIG. 4A, the apparatus 120 is inserted within the enclosed structure 100 through the opening 110 at a first orientation ‘FO’. The clamp member 122 may define a length extending between the first arm 126 and the second arm 128. The length of the clamp member 122 is smaller than the length of the opening 110. In the first orientation ‘FO’, the clamp member 122 is aligned with the longitudinal axis ‘LA’ of the opening 110. As the thickness ‘CT’ of the clamp member 122 and the outer diameter ‘OD’ of the support member 134 is less than the second width ‘W2’ of the opening 110, the apparatus 120 is conveniently inserted within the enclosed structure 100. In an embodiment, the apparatus 120 may be manually inserted within the enclosed structure 100. In other embodiments, the apparatus 120 may be inserted within the enclosed structure 100 via the alignment tool 116 or any other device. Further, the second end 134B of the support member 134 is configured to abut the second plate 104 of the enclosed structure 100. As the overall length ‘OL’ of the apparatus 120 is greater than the height ‘H’ of the enclosed structure 100, once the support member 134 is vertically disposed within the enclosed structure 100, the clamp member 122 protrudes from the opening 110.

Further, the alignment tool 116 is engaged with the cutout 124A of the clamp member 122. In the illustrated embodiment, the alignment tool 116 includes a shank 116A having a first end 116B configured to engage with the cutout 124A. The shank 116A further includes a second end 116C coupled to a handle 116D to facilitate gripping by an operator. The shank 116A may have a circular cross section having an outer diameter less than the second width ‘W2’ of the opening 110 such that the alignment tool 116 may be inserted through the opening 110. In an example, the alignment tool 116 may be a screw driver. In other embodiments, any other type of tool may be inserted through the opening 110 and engaged with the cutout 124A. The alignment tool 116 is further pushed downward such that the clamp member 122 moves away from the first plate 102 along the rotation axis ‘RA’ against a biasing force of the spring member 136. The alignment tool 116 may be pushed downward till the overall length ‘OL’ of the apparatus 120 becomes equal or less than the height ‘H’ of the enclosed structure 100. The alignment tool 116 is further moved to rotate the clamp member 122 about the rotation axis ‘RA’ to move the apparatus 120 from the first orientation ‘FO’ to a second orientation ‘SO’. In the second orientation ‘SO’, as illustrated in FIG. 4B, the clamp member 122 is oriented at an angle ‘A’ with respect to the longitudinal axis ‘LA’ of the opening 110. In the second orientation ‘SO’, the clamp member 122 may be oriented at about 90 degrees with respect to the longitudinal axis ‘LA’. However, it may be contemplated that in the second orientation ‘SO’, the clamp member 122 may be oriented at any angle with respect to the longitudinal axis ‘LA’ to receive the backing member 112 within the space 130 (shown in FIG. 6A) defined by the clamp member 122.

FIGS. 5A to 5C illustrate an exemplary method of disposing the backing member 112 within the enclosed structure 100, according to an embodiment of the present disclosure. The method includes inserting the backing member 112 within the enclosed structure 100 through the opening 110. The string 119 is inserted through each of the plurality of second through holes 118 to hold the backing member 112 in a first position ‘FP’ thereof. In the first position ‘FP’, as illustrated in FIG. 5A, a plane defined by the width ‘BW’ of the backing member 112 is oriented perpendicular to the longitudinal axis ‘LA’. Further, the thickness ‘BT’ of the backing member 112 is aligned with the second width ‘W2’ of the opening 110. As the thickness ‘BT’ of the backing member 112 is smaller than the second width ‘W2’ of the opening 110, the backing member 112 may be inserted within the enclosed structure 100 through the opening 110. Further, as the length ‘BL’ of the backing member 112 is longer than the length of the opening 110, one end of the backing member 112 is inserted through the opening 110 initially to dispose the backing member 112 within the enclosed structure 100.

Further, as shown in FIG. 5B, the backing member 112 is allowed to move from the first position ‘FP’ to a second position ‘SP’ due to self-weight. In the second position ‘SP’, the backing member 112 is aligned with the opening 110 and the plane defined by the width ‘BW’ of the backing member 112 becomes parallel to the first plate 102.

The backing member 112 is further moved towards the first plate 102 along the rotation axis ‘RA’ to contact the backing member 112 with the first plate 102. The string 119 is pulled upward such that the first surface 112A of the backing member 112 contacts with the inner surface 102B of the first plate 102. Thus, the opening 110 is closed from inside of the enclosed structure 100 by the backing member 112.

FIGS. 6A to 6C illustrate an exemplary method of engaging the backing member 112 with the apparatus 120. As shown in FIG. 6A, the method includes aligning the first through hole 114 of the backing member 112 with the cutout 124A along the rotation axis ‘RA’. Further, the first end 116B of the alignment tool 116 is inserted through the opening 110 and the first through hole 114 of the backing member 112 to engage with the cutout 124A.

The method includes moving the clamp member 122 away from the first plate 102 along the rotation axis ‘RA’ against the biasing force of the spring member 136. Specifically, the alignment tool 116 is pushed downward to move the clamp member 122 away from the backing member 112 along the rotation axis ‘RA’ against the biasing force of the spring member 136. The alignment tool 116 is further moved to rotate the clamp member 122 about the rotation axis ‘RA’ to move the apparatus 120 from the second orientation ‘SO’ to the first orientation ‘FO’. In the first orientation ‘FO’, as illustrated in FIG. 6B, the first and the second abutment surfaces 126A, 128A of the first and second arms 126, 128, respectively, abut the second surface 112B of the backing member 112. Thus, the backing member 112 is supported within the enclosed structure 100 by the apparatus 120 to enable welding of the first plate 102 along the opening 110.

The alignment tool 116 is further removed from the enclosed structure 100. Further, as illustrated in FIG. 6C, an insert 140 is disposed within the first through hole 114 to close the opening 110. The insert 140 is a cylindrical rod having an outer diameter equal to an inner diameter of the first through hole 114. The insert 140 is made from a nonmetallic material such as ceramic material. Further, a portion of the string 119 lying outside the enclosed structure 100 may be cut from the backing member 112. Remaining portion of the string 119 in the backing member 112 may melt along with the welding material during welding of the first plate 102.

### INDUSTRIAL APPLICABILITY

The present disclosure relates to the system 101 to assist the operator to weld the first plate 102 of the enclosed structure 100. The system 101 is disposed within the enclosed structure 100 to close the opening 110 via the backing member 112 and supporting the backing member 112 via the apparatus 120. The present disclosure also relates to a method 200 of supporting the backing member 112, via the apparatus 120, in the enclosed structure 100.

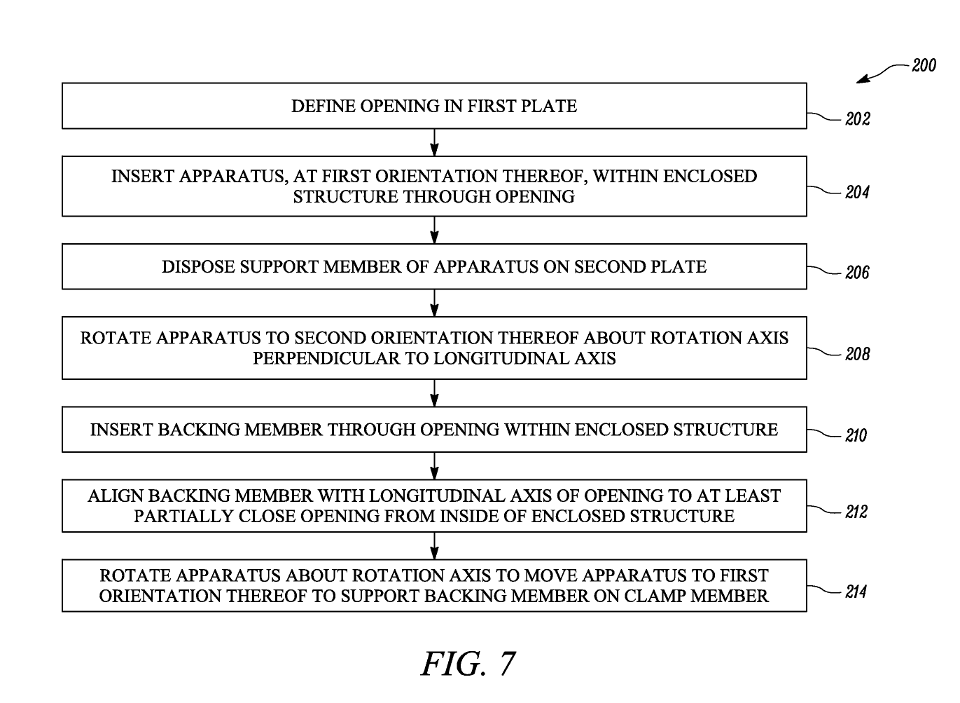

FIG. 7 illustrates a flow chart of the method 200 of supporting the backing member 112 within the enclosed structure 100, according to an embodiment of the present disclosure. At step 202, the method 200 includes defining the opening 110 in the first plate 102. The opening 110 may be defined at any location in the enclosed structure 100 to repair the enclosed structure 100. At step 204, the method 200 includes inserting the apparatus 120 at the first orientation ‘FO’ thereof within the enclosed structure 100 through the opening 110. The clamp member 122 and the support member 134 may be aligned with the longitudinal axis ‘LA’ of the opening 110 to insert the apparatus 120 through the opening 110. In an embodiment, the second width ‘W2’ of the opening 110 may be defined based on the thickness ‘CT’ of the clamp member 122 and the outer diameter ‘OD’ of the support member 134.

At step 206, the method 200 includes disposing the support member 134 on the second plate 104. The second end 134B of the support member 134 is made to contact with the second plate 104 to vertically dispose the apparatus 120 within the enclosed structure 100. In an embodiment, the clamp member 122 is moved away from the first plate 102, along the rotation axis ‘RA’, against the biasing force of the spring member 136. At step 208, the method 200 includes rotating the apparatus 120 to the second orientation ‘SO’ thereof about the rotation axis ‘RA’ perpendicular to the longitudinal axis ‘LA’.

At step 210, the method 200 includes inserting the backing member 112 through the opening 110 within the enclosed structure 100. In an embodiment, the backing member 112 is suspended by the string 119 in the first position ‘FP’ thereof to insert the backing member 112 within the enclosed structure 100 through the opening 110. Further, the backing member 112 is allowed to move from the first position ‘FP’ to the second position ‘SP’. The string 119 is pulled upward to move the backing member 112 towards the first plate 102, along the rotation axis ‘RA’, to contact the backing member 112 with the first plate 102. At step 212, the method 200 includes aligning the backing member 112 with the longitudinal axis ‘LA’ of the opening 110 to at least partially close the opening 110 from inside of the enclosed structure 100.

At step 214, the method 200 includes rotating the apparatus 120 about the rotation axis ‘RA’ to move the apparatus 120 to the first orientation ‘FO’ thereof to support the backing member 112 on the clamp member 122. In an embodiment, the alignment tool 116 is inserted through the first through hole 114 defined in the backing member 112 to engage with the cutout 124A of the clamp member 122. The clamp member 122 is further moved away from the first plate 102, along the rotation axis ‘RA’, against the biasing force of the spring member 136 to rotate the clamp member 122 and to move the apparatus 120 to the first orientation ‘FO’ thereof to bias the backing member 112 against the first plate 102. The alignment tool 116 is further removed from the enclosed structure 100 and the insert 140 is disposed within the first through hole 114 of the backing member 112. Thus the opening 110 is completely closed from inside of the enclosed structure 100 to define a weld joint in the first plate 102 along the opening 110.

According to the present disclosure, as the apparatus 120 is inserted through the opening 110, the backing member 112 is supported from inside of the enclosed structure 100 without any additional modification in the enclosed structure 100. Thus groove weld joint in the enclosed structure 100 is performed from outside of the enclosed structure 100 in short duration at less cost. Further, inspection of the weld quality is also performed from outside of the enclosed structure 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An apparatus for supporting a backing member for welding a first plate of an enclosed structure, the first plate defining an opening therethrough, the apparatus configured to be disposed within the enclosed structure, the apparatus comprising:
a clamp member; and
a support member configured to rotatably support the clamp member, wherein the clamp member is rotatable about a rotation axis defined by the support member, the support member further configured to abut a second plate spaced apart from the first plate;
wherein the clamp member is configured to be moved along the rotation axis relative to the support member and bias the backing member to contact with the first plate along the opening.

2. The apparatus of claim 1, wherein the clamp member comprises:
a base;
a first arm extending from the base in a first direction, the first arm defining a first abutment surface configured to abut the backing member;
a second arm extending from the base in a second direction opposite to the first direction, the second arm defining a second abutment surface configured to abut the backing member; and
an elongate member extending from the base and configured to be rotatably received within the support member.

3. The apparatus of claim 2, wherein the base defines a cutout to engage with an alignment tool received through the opening.

4. The apparatus of claim 2 further comprising a spring member disposed between the clamp member and the support member, the spring member configured to bias the clamp member along the rotation axis.

5. The apparatus of claim 4, wherein the clamp member further comprises a first flange and the support member comprises a second flange, and wherein the spring member is supported between the first flange and the second flange.

6. The apparatus of claim 2 further comprising a plurality notches defined on the first abutment surface of the first arm and the second abutment surface of the second arm.

7. A system for welding a first plate of an enclosed structure, the first plate defining an opening therethrough, the system configured to be disposed within the enclosed structure, the system comprising:
a backing member defining a first surface and a second surface distal to the first surface; and
an apparatus for supporting the backing member, the apparatus comprising:
a clamp member configured to abut the second surface of the backing member, wherein the first surface of the backing member is configured to abut the first plate; and
a support member configured to rotatably support the clamp member, wherein the clamp member is rotatable about a rotation axis defined by the support member, the support member further configured to abut a second plate spaced apart from the first plate;
wherein the clamp member is configured to be moved along the rotation axis relative to the support member and bias the backing member to contact with the first plate along the opening.

8. The system of claim 7, wherein the backing member comprises a first through hole configured to receive an alignment tool therethrough.

9. The system of claim 7, wherein the backing member comprises a plurality of second through holes spaced from each other to receive a string therethrough.

10. The system of claim 7, wherein the clamp member comprises:
a base;
a first arm extending from the base in a first direction, the first arm defining a first abutment surface configured to abut the backing member;
a second arm extending from the base in a second direction opposite to the first direction, the second arm defining a second abutment surface configured to abut the backing member; and
an elongate member extending from the base and configured to be rotatably received within the support member.

11. The system of claim 10, wherein the base defines a cutout to engage with an alignment tool received through the opening.

12. The system of claim 10 further comprising a spring member disposed between the clamp member and the support member, the spring member configured to bias the clamp member along the rotation axis.

13. The system of claim 12, wherein the clamp member further comprises a first flange and the support member comprises a second flange, and wherein the spring member is supported between the first flange and the second flange.

14. The system of claim 10 further comprising a plurality notches defined on the first abutment surface of the first arm and the second abutment surface of the second arm.

15. A method of supporting a backing member in an enclosed structure having a first plate and a second plate spaced apart from the first plate, the method comprising:
defining an opening in the first plate, the opening having a longitudinal axis;
inserting an apparatus, at a first orientation thereof, within the enclosed structure through the opening, the apparatus comprising a clamp member and a support member configured to rotatably support the clamp member, wherein, in the first orientation, the clamp member is aligned with the longitudinal axis of the opening;
disposing the support member of the apparatus on the second plate;
rotating the apparatus to a second orientation thereof about a rotation axis perpendicular to the longitudinal axis, wherein, in the second orientation, the clamp member is oriented at an angle with respect to the longitudinal axis of the opening;
inserting a backing member through the opening within the enclosed structure;
aligning the backing member with the longitudinal axis of the opening to at least partially close the opening from inside of the enclosed structure; and
rotating the apparatus about the rotation axis to move the apparatus to the first orientation thereof to support the backing member on the clamp member.

16. The method of claim 15 further comprising:
moving, via an alignment tool, the clamp member away from the first plate along the rotation axis against a biasing force of a spring member, wherein the spring member is disposed between the clamp member and the support member; and
rotating, via the alignment tool, the clamp member about the rotation axis to move the apparatus to the second orientation.

17. The method of claim 16 further comprising holding the backing member, in a first position thereof, by a string, wherein the string is inserted through a plurality of second through holes defined in the backing member, and wherein, in the first position, the backing member is oriented perpendicular to the longitudinal axis.

18. The method of claim 17, wherein aligning the backing member with the longitudinal axis of the opening further comprises:
allowing the backing member to move from the first position to a second position, wherein, in the second position, the backing member is aligned with the opening; and
moving, via the string, the backing member towards the first plate along the rotation axis to contact the backing member with the first plate.

19. The method of claim 18 further comprising:
inserting the alignment tool through a first through hole defined in the backing member;
engaging the alignment tool with a cutout defined in the clamp member;
moving the clamp member away from the first plate along the rotation axis against the biasing force of the spring member; and
rotating the clamp member to move the apparatus to the first orientation thereof to bias the backing member against the first plate.

20. The method of claim 19 further comprising closing the first through hole defined in the backing member via an insert.
